(19) United States
(12) Patent Application Publication
(10) Pub. No.: US 2026/0145648 A1
(43) Pub. Date: May 28, 2026

(54) WIPER BLADE APPARATUS

(71) Applicant: DY AUTO Corporation, Asan-si (KR)

(72) Inventor: Kun Woo Choung, Asan-si (KR)

(73) Assignee: DY AUTO Corporation, Asan-si (KR)

(21) Appl. No.: 19/397,704

(22) Filed: Nov. 21, 2025

(30) Foreign Application Priority Data
Nov. 22, 2024 (KR) 10-2024-0168906

(51) Int. Cl. B60S 1/38; B60S 1/52

(52) U.S. Cl. CPC B60S 1/3806; B60S 1/524

(57) ABSTRACT

Provided is a wiper blade apparatus including a support member, a spoiler member including a support member accommodation portion, a blade holding portion, and a spoiler portion, a wiper blade coupled to the blade holding portion, and an arm connector, wherein the spoiler member has a cleaning fluid passage, and the cleaning fluid passage includes a nozzle installation portion having an open structure in which the cleaning fluid passage is cut at multiple positions spaced apart along the longitudinal direction of the spoiler member. The wiper blade apparatus further includes a pair of protruding coupling portions arranged in the nozzle installation portion, coupled in a form inserted into the cleaning fluid passage, and protruding on a same line in opposite directions, and a plurality of spray modules configured to spray the cleaning fluid outward. The spray module is detachably coupled to the spoiler member.

### CROSS REFERENCE TO RELATED APPLICATION

This application is based on and claims priority under 35 U.S.C. §119 to Korean Patent Application No. 10-2024-0168906, filed on November 22, 2024, in the Korean Intellectual Property Office, the disclosure of which is incorporated by reference herein in its entirety.

### FIELD

The disclosure relates to a wiper blade apparatus for removing foreign objects from a windshield of a vehicle, and more particularly, to a structure in which a cleaning fluid spray module is provided on a spoiler member.

### BACKGROUND

In general, vehicles are provided with wiper apparatuses for removing foreign objects from the surface of a windshield glass and a rear window glass. Wiper apparatuses perform the function of ensuring a driver's field of vision by causing a motor to move wiper blades so as to wipe the surface of a windshield.

In a traditional wiper apparatus, a rotational motion of a wiper motor is transmitted to a wiper arm through a link mechanism and a pivot, and the wiper arm performs a left/right reciprocating rotational motion at a set angle. Accordingly, the wiper blade apparatus installed at the front end of the wiper arm wipes the surface of the windshield while moving together with the wiper arm.

Recent wiper blade apparatuses are trending towards including spoiler members to ensure smooth operations of wiper blade apparatuses during high-speed driving. In particular, flat wiper blade apparatuses include a metal support member (vertebra) coupled to a spoiler member, which reduces the size of the wiper blade apparatus and omits a structure that may impede air flow between the windshield and the wiper blade apparatus. Accordingly, flat wiper blade apparatuses are widely employed.

A spray nozzle is provided to spray cleaning fluid to reduce friction between the windshield and the wiper blade apparatus when the wiper blade apparatus is in operation and to

remove foreign objects more effectively. A traditional cleaning fluid spray nozzle is installed in a cowl or a hood of an engine room of a vehicle. Recently, a cleaning fluid spray nozzle may be installed in an arm connector, which is a device for connecting a wiper blade apparatus to a wiper arm. Furthermore, a cleaning fluid spray nozzle may be provided integrally with a spoiler member that constitutes a wiper blade apparatus. When the cleaning fluid spray nozzle is provided in the spoiler member, it is more effective in removing foreign objects from the surface of the windshield. However, when the cleaning fluid spray nozzle is provided integrally with the spoiler member, the entire wiper blade has to be replaced when the nozzle becomes clogged or malfunctions, which increases maintenance and replacement costs.

### SUMMARY

Provided is a wiper blade apparatus that has excellent spray efficiency and reduced maintenance and replacement costs by improving an arrangement structure of a cleaning fluid spray module provided in the wiper blade apparatus.

Additional aspects will be set forth in part in the description which follows and, in part, will be apparent from the description, or may be learned by practice of the presented embodiments of the disclosure.

According to an aspect of the disclosure, a wiper blade apparatus includes a support member formed of a metal plate in an elongated bar shape, a spoiler member including a support member accommodation portion to which the support member is coupled, a blade holding portion arranged at a lower portion thereof and to which a wiper blade is slidingly coupled, and a spoiler portion arranged at an upper portion thereof and configured to generate a pressing force downward due to air flow, the wiper blade coupled to the blade holding portion and configured to come into contact with a windshield of a vehicle and remove foreign objects from the windshield, and an arm connector arranged at a central portion of the support member and fixed to the spoiler member, and to which a wiper arm is coupled, wherein the spoiler member has a cleaning fluid passage through which cleaning fluid is transferred along a longitudinal direction, and the cleaning fluid passage includes a nozzle installation portion having an open structure in which the cleaning fluid passage is cut at multiple positions spaced apart along the longitudinal direction of the spoiler member, the wiper blade apparatus further including a plurality of spray modules configured to spray the cleaning fluid outward in jet form, wherein the plurality of spray modules have a pair of protruding coupling portions arranged in the nozzle installation portion, coupled in a form inserted into the cleaning fluid passage, and protruding on a same line in opposite directions, and the spray module is detachably coupled to the spoiler member.

One of the plurality of spray modules may be a combined cleaning fluid supply module having a cleaning fluid injection portion coupled to a hose and into which cleaning fluid supplied from a cleaning fluid tank is introduced.

The combined cleaning fluid supply module may include therein a buffer space capable of temporarily storing the cleaning fluid.

The combined cleaning fluid supply module may be arranged at a position spaced apart from the arm connector toward a rear end of the wiper arm in the longitudinal direction.

The combined cleaning fluid supply module may be arranged such that an upper portion thereof is covered by the wiper arm.

The spray module may have a hook structure coupled in a form surrounding edges of the spoiler member.

The spray module may have at least one spray structure, and spray holes may be configured to spray the cleaning fluid in different directions.

The wiper blade apparatus may further include a quick coupler having a passage in which one end portion thereof communicates with the hose and another end portion thereof communicates with the cleaning fluid injection port, wherein the quick coupler may be detachably coupled to the cleaning fluid injection portion.

The quick coupler may include a pair of elastic hooks protruding toward the cleaning fluid injection portion, and a stopper protruding in a cantilever shape may be provided on an outer circumferential surface of the cleaning fluid injection portion, so as to be coupled to the pair of elastic hooks.

The wiper blade apparatus may further include a positioning protrusion provided in the quick coupler and protruding toward an upper surface of the cleaning fluid injection portion, and a positioning groove provided in the upper surface of the cleaning fluid injection portion and accommodating the positioning protrusion.

The positioning groove may be formed to become wider in an upward direction such that the positioning protrusion accommodated in the positioning groove is pushed upward when the quick coupler is rotated in a circumferential direction of the cleaning fluid injection portion.

One of the pair of protruding coupling portions provided in a spray module arranged closest to opposite end portions of the spoiler member in the longitudinal direction among the plurality of spray modules may have a closed structure.

The stopper may have an inclined surface that guides a gap between front ends of the pair of elastic hooks to become wider in a process in which the elastic hooks are coupled.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating a state in which a wiper blade apparatus according to an embodiment is coupled to a wiper arm;

FIG. 2 is an exploded perspective view of main components illustrated in FIG. 1;

FIG. 3 is a cross-sectional view taken along line III-III of FIG. 1;

FIG. 4 is a cross-sectional view taken along line IV-IV of FIG. 1;

FIG. 5 is a cross-sectional view taken along line V-V of FIG. 1;

FIG. 6 is a diagram illustrating a three-dimensional structure of a spray module illustrated in FIG. 3;

FIG. 7 is a diagram illustrating a three-dimensional structure of a combined cleaning fluid supply module illustrated in FIG. 4;

FIG. 8 is a diagram illustrating a three-dimensional structure of a quick coupler illustrated in FIG. 4; and

FIG. 9 is a diagram illustrating a state in which a combined cleaning fluid supply module and a quick coupler are coupled to each other.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term "and/or" includes any and all combinations of one or more of the associated listed items. Expressions such as "at least one of," when preceding a list of elements, modify the entire list of elements and do not modify the individual elements of the list.

Hereinafter, embodiments will be described in detail with reference to the accompanying drawings, so that those of ordinary skill in the art may easily carry out the disclosure. However, the disclosure may be implemented in various different forms and is not limited to embodiments described herein. However, in describing embodiments in detail, when the detailed description of the relevant known functions or configurations is determined to unnecessarily obscure the gist of the disclosure, the detailed description thereof is omitted herein. In addition, parts that have similar functions and operations are denoted by the same reference numerals and/or symbols throughout the drawings.

It will be understood that the terms "comprise" or "include" as used herein specify the presence of stated elements, but do not preclude the presence or addition of one or more other elements. Specifically, the terms "comprise," "include," or "have" as used herein are inclusive and therefore specify the presence of one or more stated features, integers, steps, operations, elements, components, or any combination thereof, but do not preclude the presence or addition of one or more other features, integers, steps, operations, elements, components, or any combination thereof.

The singular forms as used herein are intended to include the plural forms as well unless the context clearly indicates otherwise. Furthermore, the shapes and sizes of elements in the drawing may be exaggerated for clearer explanation.

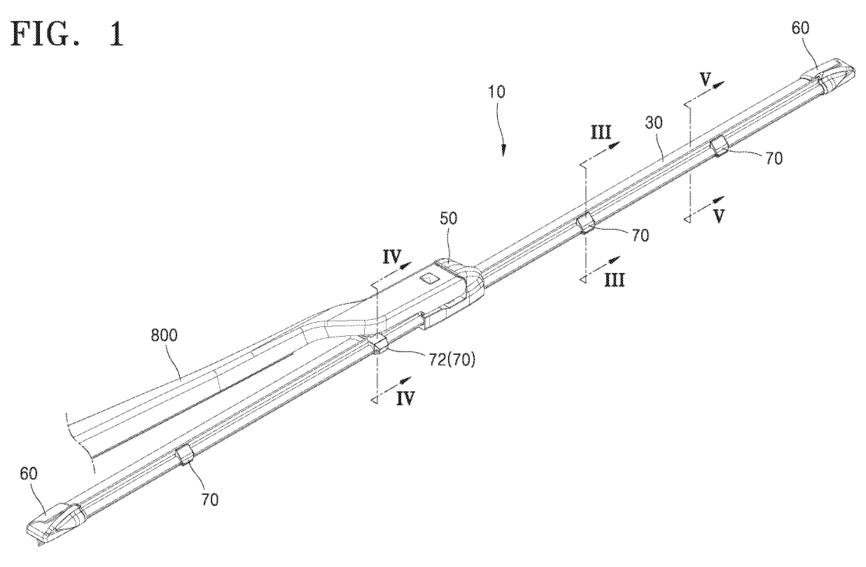

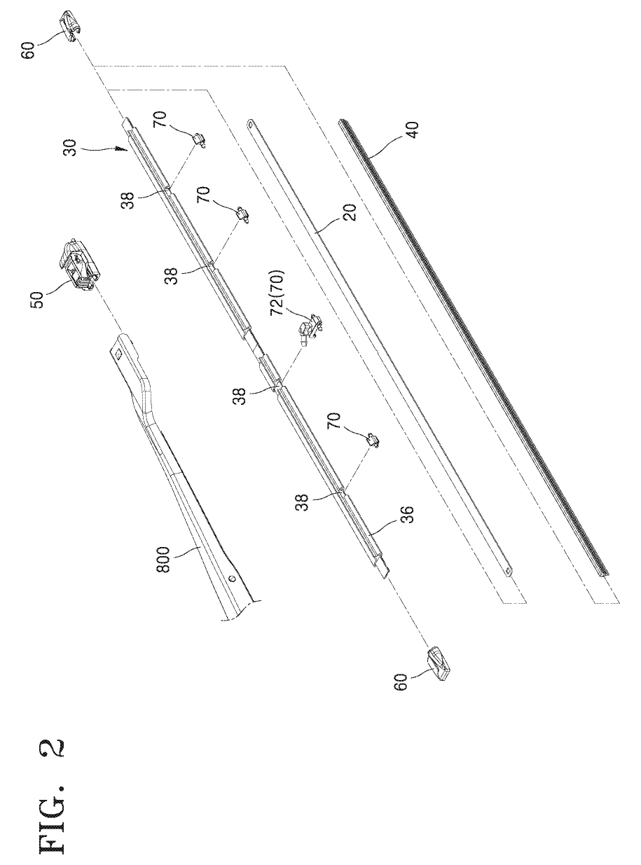

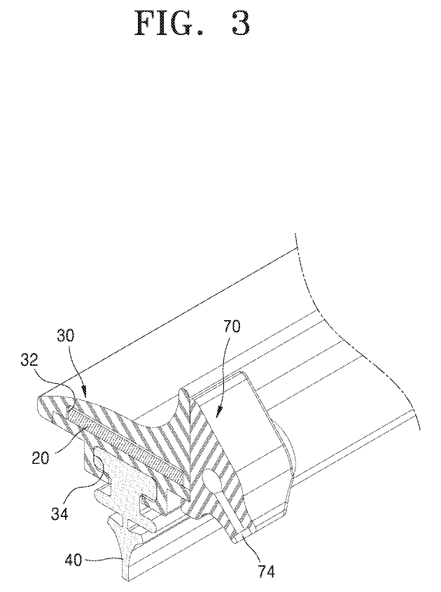

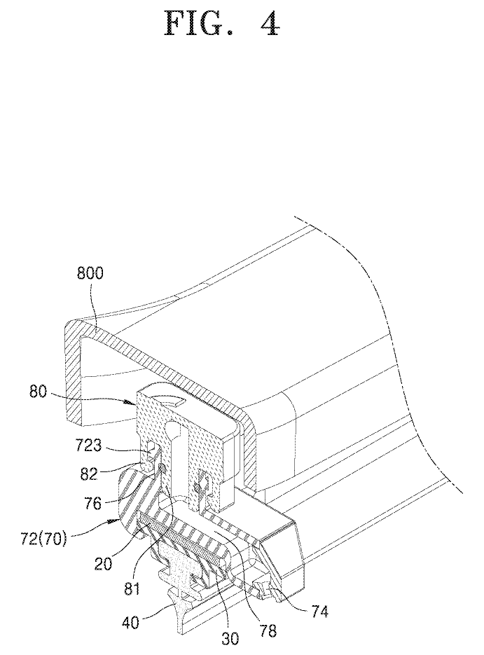

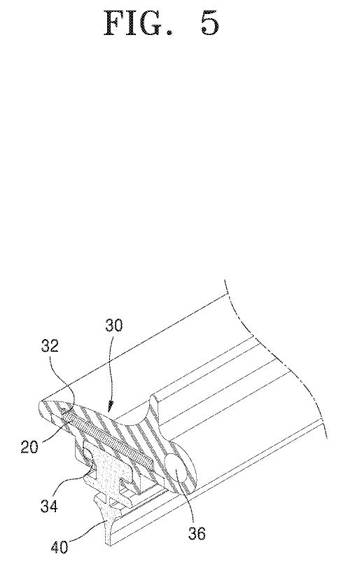

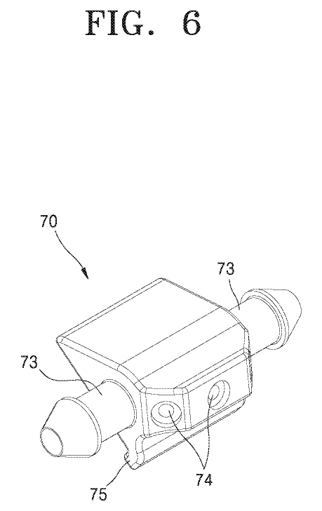

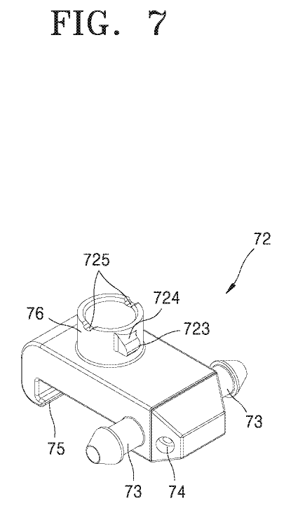

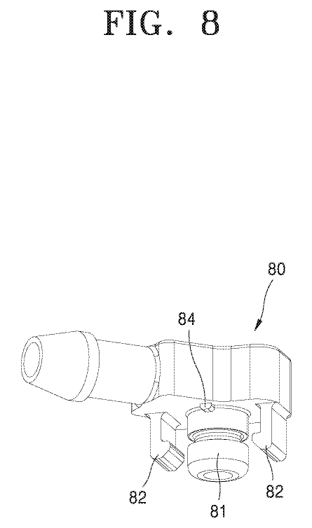

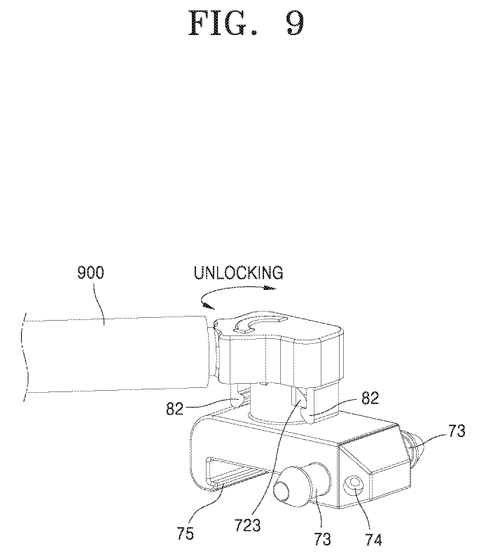

FIG. 1 is a diagram illustrating a state in which a wiper blade apparatus according to an embodiment is coupled to a wiper arm. FIG. 2 is an exploded perspective view of main components illustrated in FIG. 1. FIG. 3 is a cross-sectional view taken along line III-III of FIG. 1. FIG. 4 is a cross-sectional view taken along line IV-IV of FIG. 1. FIG. 5 is a cross-sectional view taken along line V-V of FIG. 1. FIG. 6 is a diagram illustrating a three-dimensional structure of a spray module illustrated in FIG. 3. FIG. 7 is a diagram illustrating a three-dimensional structure of a combined cleaning fluid supply module illustrated in FIG. 4. FIG. 8 is a diagram illustrating a three-dimensional structure of a quick coupler illustrated in FIG. 4. FIG. 9 is a diagram illustrating a state in which the combined cleaning fluid supply module and the quick coupler are coupled to each other.

Referring to FIGS. 1 to 9, a wiper blade apparatus 10 according to the disclosure may include a support member (vertebra) 20, a spoiler member 30, a wiper blade 40, an arm connector 50, end caps 60, and a spray module 70.

The support member 20 may include metal. The support member 20 may include, for example, stainless steel or carbon steel. The support member 20 may be formed by processing a plate-shaped metal into an elongated rod shape. The support member 20 may be employed to provide an elastic restoring force to the wiper blade 40 to be described below.

The spoiler member 30 may be formed of synthetic resin. The spoiler member 30 may perform one or more functions. The spoiler member 30 may accommodate the support member 20. The spoiler member 30 may include a tunnel-shaped support member accommodation portion 32 to which the support member 20 is coupled. The support member accommodation portion 32 may be a hole penetrating in a longitudinal direction of the spoiler member 30.

The spoiler member 30 may include a blade holding portion 34. The blade holding portion 34 may be provided at a lower portion of the spoiler member 30. The blade holding portion 34 may be configured in the form of a groove with an open bottom. The wiper blade 40 may be slidingly coupled to the blade holding portion 34.

The spoiler member 30 may include a spoiler portion. The spoiler portion may be formed at the upper end portion of the spoiler member 30. The spoiler portion may have a shape to generate a pressing force downward of the spoiler member 30 due to air flow.

The spoiler member 30 may be provided in pair. In this case, the spoiler members 30 may be respectively arranged on opposite sides with respect to the center of the arm connector 50 to be described below.

The spoiler member 30 may have a cleaning fluid passage 36 for spraying cleaning fluid. The cleaning fluid passage 36 is a passage formed along the longitudinal direction of the spoiler member 30. The cleaning fluid passage 36 may be formed integrally with the spoiler member 30. The cleaning fluid may be transferred through the cleaning fluid passage 36.

The spoiler member 30 may include a plurality of nozzle installation portions 38.

The plurality of nozzle installation portions 38 may be formed by cutting a portion of the cleaning fluid passage 36. The plurality of nozzle installation portions 38 may be arranged at positions spaced apart along the longitudinal direction of the spoiler member 30. In an embodiment, the nozzle installation portions 38 are provided at four positions. The nozzle installation portions 38 may form an open structure in which the cleaning fluid passage 36 is cut off.

The spray module 70 may be installed in each of the nozzle installation portions 38. That is, the spray module 70 may be provided in plurality. The spray module 70 is described below.

The wiper blade 40 may include a material such as rubber. The wiper blade 40 may be coupled to the blade holding portion 34. The wiper blade 40 may be coupled to the blade holding portion 34 in a sliding structure. The wiper blade 40 may come into contact with the windshield of the vehicle and remove foreign objects from the windshield. The upper portion of the wiper blade 40 may be coupled to the blade holding portion 34, and the lower portion of the wiper blade 40 may protrude toward the lower end of the spoiler member 30.

The arm connector 50 may be arranged in the central portion of the support member 20. The arm connector 50 may be arranged in the form fixed to the spoiler member 30. The arm connector 50 may have a passage that communicates with the cleaning fluid passage 36 formed in the spoiler member 30. A wiper arm 800 may be coupled to the arm connector 50. Hereinafter, an end portion of the wiper arm 800 that is coupled to the arm connector 50 in the longitudinal direction is defined as a front end. An end portion opposite to the end portion of the wiper arm 800 that is coupled to the arm connector 50 in the longitudinal direction is defined as a rear end.

The arm connector 50 may allow the spoiler member 30 to be coupled. The arm connector 50 may include a plurality of members coupled to each other. The wiper arm 800 may be detachably coupled to the arm connector 50.

The end caps 60 may be respectively coupled to opposite end portions of the spoiler member 30. The end cap 60 may be manufactured by injection-molding synthetic resin.

The spray module 70 may include a pair of protruding coupling portions 73 and a nozzle 74.

The pair of protruding coupling portions 73 may be arranged on the same line in the longitudinal direction of the cleaning fluid passage 36. The pair of protruding coupling portions 73 may be formed to protrude in opposite directions. The protruding coupling portions 73 may be coupled in the form inserted into the cleaning fluid passage 36. The pair of protruding coupling portions 73 may communicate with each other such that the cleaning fluid may be introduced and discharged. The spray module 70 may include the nozzle 74 that sprays the cleaning fluid outward in jet form.

The spray module 70 may be detachably coupled to the spoiler member 30.

For example, the spray module 70 may have at least one spray structure, and spray holes may be configured to spray the cleaning fluid in different directions.

One of the spray modules 70 may be a combined cleaning fluid supply module 72 including a cleaning fluid injection portion 76 coupled to a hose 900 and into which cleaning fluid supplied from a cleaning fluid tank (not shown) is introduced. The cleaning fluid injection portion 76 may be a chimney-shaped structure protruding upward from the combined cleaning fluid supply module 72.

In an embodiment, a buffer space 78 capable of temporarily storing the cleaning fluid may be provided inside the combined cleaning fluid supply module 72. The buffer space 78 may temporarily store the cleaning fluid injected through the hose 900. Due to the buffer space 78, the cleaning fluid may be immediately transferred to the cleaning fluid passage 36. The buffer space 78 may communicate with the cleaning fluid injection portion 76. In addition, the buffer space 78 may be configured to communicate with the protruding coupling portion 73.

The combined cleaning fluid supply module 72 may be arranged at a position spaced apart from the arm connector 50 toward the rear end portion of the wiper arm 800 in the longitudinal direction. In addition, the combined cleaning fluid supply module 72 may be arranged such that the upper portion of the combined cleaning fluid supply module 72 is covered by the wiper arm 800. Accordingly, because the hose 900 is coupled to the combined cleaning fluid supply module 72, an effect of preventing the hose 900 or a quick coupler 80 to be described below from being detached from the combined cleaning fluid supply module 72 when exposed to an unexpected external force may be provided. Furthermore, because the quick coupler 80 is not visible from the outside, an aesthetically pleasing effect may be provided.

The spray module 70 may have a hook structure 75 coupled in the form surrounding edges of the spoiler member 30. The hook structure 75 may maintain the spray module 70 in a state of being stably coupled to the spoiler member 30 in cooperation with the protruding coupling portions 73 provided in the spray module 70.

The combined cleaning fluid supply module 72 may include the quick coupler 80.

The quick coupler 80 may have a passage in which one end portion thereof communicates with the hose 900 and another end portion thereof communicates with the cleaning fluid injection portion 76. The quick coupler 80 may be detachably coupled to the cleaning fluid injection portion 76. The quick coupler 80 may include an injection tube portion 81 protruding so as to be inserted along an inner circumferential surface of the cleaning fluid injection portion 76. An O-ring may be installed on an outer circumferential surface of the injection tube portion 81.

The quick coupler 80 may include a pair of elastic hooks 82 protruding toward the cleaning fluid injection portion 76. A stopper 723 protruding in a cantilever shape may be provided on an outer circumferential surface of the cleaning fluid injection portion 76, so as to be coupled to each of the elastic hooks 82. Because the elastic hook 82 is caught by the stopper 723, the quick coupler 80 may maintain a state of being coupled to a body of the combined cleaning fluid supply module 72. The elastic hooks 82 may be provided in pair, and the pair of elastic hooks 82 may be spaced 180° apart along the circumference of the cleaning fluid injection portion 76.

The stopper 723 may have an inclined surface 724 that guides a gap between the front ends of the elastic hooks 82 to become wider in a process in which the elastic hooks 82 are coupled.

The quick coupler 80 may include a positioning protrusion 84.

The positioning protrusion 84 may be arranged at a position spaced apart from a position where the elastic hook 82 is arranged. For example, the positioning protrusion 84 may be arranged at a position spaced 90° apart from the elastic hook 82. The positioning protrusion 84 may be a protruding structure that protrudes toward the upper surface of the cleaning fluid injection portion 76.

The cleaning fluid injection portion 76 may include a positioning groove 725.

The positioning groove 725 may be a structure corresponding to the positioning protrusion 84. The positioning groove 725 may be provided on the upper surface of the cleaning fluid injection portion 76. The positioning groove 725 may accommodate the positioning protrusion 84. The positioning protrusion 84 and the positioning groove 725 may each be provided in pair.

The positioning groove 725 may be formed to become wider in an upward direction such that the positioning protrusion 84 accommodated in the positioning groove 725 is pushed upward when the quick coupler 80 is rotated in the circumferential direction of the cleaning fluid injection portion 76.

One of the pair of protruding coupling portions 73 provided in the plurality of spray modules 70 may have a closed structure. For example, one of the pair of protruding coupling portions 73 provided in the spray module 70 arranged closest to opposite end portions of the spoiler member 30 in the longitudinal direction may have a closed structure. Because the spray modules 70 arranged on opposite end portions no longer needs to transfer the cleaning fluid, it is desirable that the protruding coupling portion 73 close to the end portion may have a closed structure.

Hereinafter, the operational effect of the wiper blade apparatus 10 including the above-described components is described in detail by using the process of assembling and installing the wiper blade apparatus 10 as an example.

First, the process of assembling the wiper blade apparatus 10 is described. The plurality of spray modules 70 may be coupled to the spoiler member 30. In this process, the protruding coupling portion 73 may be assembled in the form inserted into the cleaning fluid passage 36 formed in the spoiler member 30. Additionally, the hook structure 75 may be fixed in the form surrounding edges of the spoiler member 30. Next, the support member 20 may be coupled to the spoiler member 30. The arm connector 50 may be installed in the central portion of the support member 20. In this state, the wiper blade 40 may be slidingly coupled to the spoiler member 30. Thereafter, the end caps 60 may be coupled to the spoiler member 30. Through these processes, the assembly of the wiper blade apparatus 10 is completed. The wiper blade apparatus 10 may be installed in a vehicle. It is assumed that the wiper arm 800 is pre-installed in the vehicle. The front end of the wiper arm 800 may be coupled to the arm connector 50. The quick coupler 80, to which the hose 900 is connected, may be coupled to the cleaning fluid injection portion 76 of the combined cleaning fluid supply module 72. More specifically, the quick coupler 80 may be pressed in a state in which the elastic hooks 82 of the quick coupler 80 are brought close to the stopper 723. A gap between the elastic hooks 82 may be widened while the elastic hooks 82 move downward along the inclined surface 724 of the stopper 723, and the elastic hooks 82 may be coupled to the stopper 723. In this process, the positioning protrusion 84 may be accommodated in the positioning groove 725, and thus, may be assembled at an accurate position. To detach the hose 900 from the combined cleaning fluid supply module 72 for the purpose of maintenance or repair, the quick coupler 80 may be held and rotated in the circumferential direction of the cleaning fluid injection portion 76. As the elastic hooks 82 are released from the stopper 723, the positioning protrusion 84 may be pushed upward along the sidewall of the positioning groove 725. As a result, the quick coupler 80 may be easily detached from the cleaning fluid injection portion 76.

In addition, when a malfunction occurs in the spray module 70, the spray module 70 may be easily detached from the spoiler member 30 by using elastic deformation of the spoiler member 30 and then repaired or replaced.

Furthermore, because the quick coupler 80 is applied, the height of the quick coupler 80 may be minimized, and thus, the quick coupler 80 may be applied even in a narrow space.

As described above, in the wiper blade apparatus according to the disclosure, the spray module that sprays the cleaning fluid may be detachably installed in the spoiler member that supports the blade. Accordingly, when a malfunction occurs in the spray module, only the spray module may be individually replaced, and thus, the wiper blade apparatus may be efficient in maintenance and replacement.

In addition, because the combined cleaning fluid supply module is easily attached to and detached from the hose by the quick coupler, the installation and detachment work time may be reduced.

Furthermore, the structure in which the upper portion of the combined cleaning fluid supply module is covered by the wiper arm may prevent the connection between the combined cleaning fluid supply module and the hose from being damaged by an unexpected external force.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

1. A wiper blade apparatus comprising:
a support member formed of a metal plate having an elongated bar shape;
a spoiler member including a support member accommodation portion to which the support member is coupled, a blade holding portion arranged at a lower portion thereof and to which a wiper blade is slidingly coupled, and a spoiler portion arranged at an upper portion thereof and configured to generate a pressing force downward due to air flow;
the wiper blade coupled to the blade holding portion and configured to come into contact with a windshield of a vehicle and remove foreign objects from the windshield; and
an arm connector arranged at a central portion of the support member and fixed to the spoiler member, and to which a wiper arm is coupled, wherein the spoiler member has a cleaning fluid passage through which cleaning fluid is transferred along a longitudinal direction, and the cleaning fluid passage comprises a nozzle installation portion having an open structure in which the cleaning fluid passage is cut at multiple positions spaced apart along the longitudinal direction of the spoiler member,
the wiper blade apparatus further comprising a plurality of spray modules configured to spray the cleaning fluid outward in jet form, wherein the plurality of spray modules have a pair of protruding coupling portions arranged in the nozzle installation portion, coupled in a form inserted into the cleaning fluid passage, and protruding on a same line in opposite directions,
wherein the spray module is detachably coupled to the spoiler member,
one of the plurality of spray modules is a combined cleaning fluid supply module having a cleaning fluid injection portion coupled to a hose and into which cleaning fluid supplied from a cleaning fluid tank is introduced, and
the combined cleaning fluid supply module comprises therein a buffer space capable of temporarily storing the cleaning fluid.

2. The wiper blade apparatus of claim 1, wherein the combined cleaning fluid supply module is arranged at a position spaced apart from the arm connector toward a rear end of the wiper arm in the longitudinal direction.

3. The wiper blade apparatus of claim 1, wherein the combined cleaning fluid supply module is arranged such that an upper portion thereof is covered by the wiper arm.

4. The wiper blade apparatus of claim 1, wherein the spray module has a hook structure coupled in a form surrounding edges of the spoiler member.

5. The wiper blade apparatus of claim 1, wherein the spray module has at least one spray structure, and spray holes are configured to spray the cleaning fluid in different directions.

6. The wiper blade apparatus of claim 1, further comprising a quick coupler having a passage in which one end portion thereof communicates with the hose and another end portion thereof communicates with the cleaning fluid injection port,
wherein the quick coupler is detachably coupled to the cleaning fluid injection portion.

7. The wiper blade apparatus of claim 6, wherein the quick coupler comprises a pair of elastic hooks protruding toward the cleaning fluid injection portion, and
a stopper protruding in a cantilever shape is provided on an outer circumferential surface of the cleaning fluid injection portion, so as to be coupled to the pair of elastic hooks.

8. The wiper blade apparatus of claim 6, further comprising:
a positioning protrusion provided in the quick coupler and protruding toward an upper surface of the cleaning fluid injection portion; and
a positioning groove provided in the upper surface of the cleaning fluid injection portion and accommodating the positioning protrusion.

9. The wiper blade apparatus of claim 8, wherein the positioning groove is formed to become wider in an upward direction such that the positioning protrusion accommodated in the positioning groove is pushed upward when the quick coupler is rotated in a circumferential direction of the cleaning fluid injection portion.

10. The wiper blade apparatus of claim 1, wherein one of the pair of protruding coupling portions provided in a spray module arranged closest to opposite end portions of the spoiler member in the longitudinal direction among the plurality of spray modules has a closed structure.

11. The wiper blade apparatus of claim 7, wherein the stopper has an inclined surface that guides a gap between front ends of the pair of elastic hooks to become wider in a process in which the elastic hooks are coupled.
